(19) United States
(12) Patent Application Publication
(10) Pub. No.: US 2005/0165761 A1
(43) Pub. Date: Jul. 28, 2005

(54) Method and apparatus for data processing and retrieval

(76) Inventors: Eric J. Chan, Hillsborough, CA (US); Mark Grandcolas, Burlingame, CA (US); David B. Bernstein, San Francisco, CA (US); Kai Laurinolli, San Francisco, CA (US)

Correspondence Address: GLENN PATENT GROUP, 3475 EDISON WAY, SUITE L, MENLO PARK, CA, 94025, US

(21) Appl. No.: 11/040,877

(22) Filed: Jan. 21, 2005

Related U.S. Application Data
(60) Provisional application No. 60/538,135, filed on Jan. 22, 2004.

(51) Int. Cl. G06F 7/00

(52) U.S. Cl. 707/3

(57) ABSTRACT

A method and apparatus in a data processing system for data content retrieval comprises steps and methods for receiving a user request; generating a first query according to the user request; querying a first database using the first query to generate a first query request; generating a second query according to the first query request; querying a second database using the second query to generate a second query request; and responding to the user request with a response according to the second query request. The method and apparatus further comprises steps and methods for filtering the second query request to generate the response, where the filtering of the second query request is according to relevance to the intent of the user request and where the second query request is filtered according to a device type.

### CROSS REFERENCE TO RELATED APPLICATIONS

This application claims priority to U.S. provisional patent application Ser. No. 60/538,135 filed Jan. 22, 2004, which application is incorporated herein in its entirety by this reference thereto.

### BACKGROUND OF THE INVENTION

1. Technical Field

The invention relates to data processing and content retrieval technology. Specifically, it relates to mobile device data processing and retrieval.

2. Description of the Prior Art

Systems for retrieval of wireless data content and services have historically required users to traverse linked menu hierarchies, which led to only limited success in both the initial discovery and repeated usage of data services such as downloadable games and ring tones. This lack of success is due to many limitations, such as the device display, the device input mechanism, the inherent limitations in using menu systems for finding information, the lack of customization of the system's offerings to the user, and the growth of available content and services. In addition, bandwidth and resource-constrained mobile devices can significantly benefit from having more processing done on the server rather than the mobile client device.

There are two primary drawbacks to the existing situation where it is difficult for users of mobile devices to find desired wireless data content and services. The first is that many or perhaps even most users of such devices find existing systems difficult to use, so that their use is frequently reduced or even abandoned. This causes user dissatisfaction with the usage of the system to find data and reduces the opportunity for satisfaction from wireless data that could have been acquired but was not.

The second major drawback to the existing situation is the economic loss suffered by creators, distributors, and vendors of wireless data content. Several private and published studies have documented the reduction in attempts to find wireless data. A recent study by Wacom Components (http://www.wacom-components.com/english/news_and_events/nw0022.asp) found that 76% of those with data-capable handsets did not use data capabilities due to their complexity of operation.

It would be advantageous to develop a type of machine that is capable of understanding of a given query to formulate an internal query of available return values and making search from a wireless device far easier, by reducing steps, providing a friendlier user interface, and providing only the most relevant return values.

### SUMMARY OF THE DESCRIPTION

One embodiment of the invention comprises a method in a data processing system for data content retrieval that comprises receiving a user request; generating a first query according to the user request; querying a first database using the first query to generate a first query request; generating a second query according to the first query request; querying a second database using the second query to generate a second query request; and responding to the user request with a response according to the second query request. The method further comprises filtering the second query request to generate the response, where filtering of the second query request is performed according to relevance to the intent of the user request, and where the second query request is filtered according to a device type.

In one embodiment of the invention, the second query request is filtered according to a preference, where the preference is indicated in previous history, geographical location and temporal changes.

In one embodiment of the invention, the second query request is filtered according to whether content has been previously acquired by a user of the request, where the user request comprises one of text input, menu selection, and voice input.

In one embodiment of the invention, the first database comprises a knowledgebase that comprises an ontology, and the second database comprises content and services. The querying of the first database comprises understanding the intent of the user request.

In one embodiment of the invention, the querying of the first database comprises translating the intent of the user request.

In one embodiment of the invention, the querying of the first database comprises expanding the intent of the user request.

In one embodiment of the invention, a machine readable medium containing instructions which, when executed on a data processing system, cause the data processing system to perform a method comprises receiving a user request, determining a user intent from the user request, and searching a database according to the user intent. The method further comprises filtering a query result from the database to generate a response to the user request. The user intent is determined according to an ontology.

In one embodiment of the invention, a data processing system comprises a user agent for receiving a user request, a service agent for determining a query for the user request according to a knowledgebase, and a search agent for searching a content database according to the query. The data processing system further comprises a personalization agent for filtering a query result from the content database to generate a personalized response to the user request. The knowledgebase comprises an ontology.

### BRIEF DESCRIPTION OF THE DRAWINGS

FIG. 1 illustrates a system for data processing and retrieval according to the invention;

FIG. 2 is a block diagram of a method of data processing for data content retrieval according to the invention;

FIG. 3 is a flow diagram of a method of data processing for data content retrieval using an SMS agent according to the invention;

FIG. 4 is a flow diagram of a method of data processing for data content retrieval using a recruiter agent according to the invention;

FIG. 5 is a flow diagram of a method of data processing for data content retrieval using a user agent according to the invention;

FIG. 6 is a flow diagram of a method of data processing for data content retrieval using a service agent according to the invention;

FIG. 7 is a flow diagram of a method of data processing for data content retrieval using a search agent according to the invention;

FIG. 8 is a flow diagram of a method of data processing for data content retrieval using a CDS agent according to the invention;

FIG. 9 is a flow diagram of a method of data processing for data content retrieval using a personalization agent according to the invention; and

FIG. 10 is a flow diagram of a method of data processing for data content retrieval using a cleaner agent according to the invention.

### DETAILED DESCRIPTION OF A PREFERRED EMBODIMENT

### DEFINITIONS

Agent Framework: a software platform for software using an agent methodology, for example, that standardized by FIPA and implemented by JADE.
CDS: Content Download Server—a system for downloading content, such as ring tones or games, to mobile devices.
CUR: Common User Repository—a repository of information about users of a mobile network.
DAML: DARPA Agent Markup Language (http://www.daml.org).
FIPA: Foundation for Intelligent Physical Agents (http://www.fipa.org/). on in this area. (http://www.geocities.com/xuchong/aglet/).
IVR: Interactive Voice Recognition: a system to interact with a person using voice
JADE: Java Agent Development Framework—the Agent Framework used in the inventive software to enable the interaction between third party software, content, and subscribers. (http://jade.tilab.com/).
Ontology: a machine-encoded model of concepts and relationships between those concepts.
OWL: Web Ontology Language (http://www.w3.org/TR/owl-features/).
RDF: Resource Description Framework (http://www.w3c.org/RDF/).
SMS: Short Message Service (mobile phone texting).
SMSC: Short Message Service Center, a machine operated to manage SMS messages in a telecommunications network.
UI: User Interface.
VXML or VoiceXML: a markup language to describe human/machine voice interaction using an IVR system.
WAP: Wireless Application Protocol: a wireless web markup language analogous to HTML.

One embodiment of the invention employs a system of data processing and content retrieval that takes an input query sent as voice, text, or menu input, interprets the meaning of the query through the use of ontologies, and translates the request into standardized machine retrieval methods. The results are returned and filtered according to the user's personal preferences, history, mobile device, location, and/or other relevant data.

Another embodiment of the invention combines the technologies of agent frameworks, ontologies, searching, search result filtering, and personalization to achieve its effect of a novel effective and friendly search system. The invention comprises of a set of agents residing on a computer, waiting for a user search request. The user of a mobile device initiates a request to find wireless data content or services. The request may be made by any preferred means including, for example, text (SMS), menu (WAP or HTML), or voice (VXML) interactions. The invention converts the words coming from the device into a query to the ontology representing relevant knowledge. The result of that knowledgebase query is a set of concepts related to the user's query. The system then converts the result of the knowledgebase query into a query of a database of available content and services. The result of the database query is returned to the user via the same type of gateway agent that handled the original incoming user input request. The filtered and personalized values are returned to the user.

The system then filters the results of the database query by criteria, such as relevance to the intent of the user of the system. After filtering, the system personalizes the returned values according to various criteria including, but not limited to, whether the content has been previously acquired by the user, the user's device type, and implicit preferences as indicated by previous purchase history.

Another embodiment of the invention may be implemented without agents. For example, one embodiment of the invention communicates with cooperating independent software programs.

Other embodiments of the invention is implemented by modules of a server system in a client or server system for the functionality of the various modules. Another embodiment of the invention comprises a single software program that implements all functionality.

Another embodiment of the invention comprises a group of multiple modules, agents, and programs that groups functionality differently. For example, the functionality of device capability match in the CDS agent can be implemented by pre-computation and an altered query of the content database. Different embodiments of the invention employ various cooperating modules, agents, and programs on one or many computers for reasons of scalability.

Other embodiments of the invention use knowledge bases found on the Internet and expressed in languages such as OWL to improve search abilities and to expand the available universe of returned results.

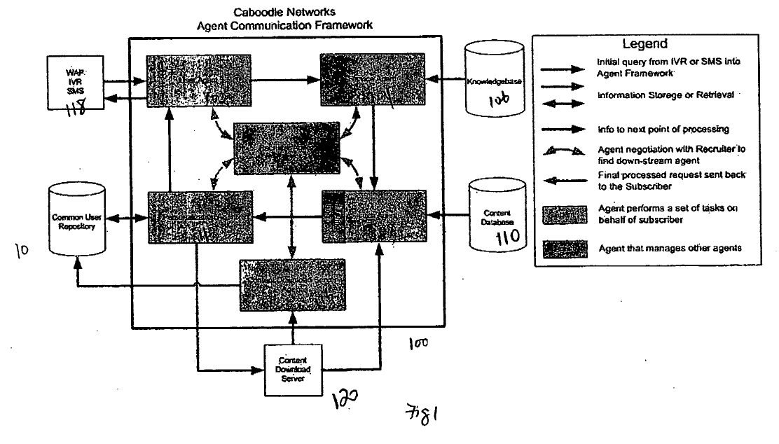

FIG. 1 illustrates a system for data processing and retrieval according to the invention. The system 100 comprises a user agent 102 for receiving a user request; a service agent 104 for determining a query for the user request according to a knowledgebase 106 which includes an ontology; a search agent 108 for searching a content database 110 according to the query; and a personalization agent 112 for filtering a query result from the content database 110 to generate a personalized response to the user request.

The system receives data input from a user via, for example, a Short Message Service (SMS) agent 118. The SMS agent 118 provides an interface to SMS gateways and converts an incoming SMS message to user requests for the user agent 102. The SMS agent then transforms end user interaction events back to the SMS message. For example, Table 1 below illustrates relevant modules in the SMS agent 118.

TABLE 1

| Module Name | Package |
|---|---|
| SmsAgent.java | com.caboodlenetworks.agents.sms |
| SmsRecruitUserInitiatorBehaviour.java | com.caboodlenetworks.agents.sms |
| SmsRecruitResponderBehaviour.java | com.caboodlenetworks.agents.sms |

input from the user via a user interface, such as a Web interface, a short message service (SMS), a wireless application protocol (WAP) mobile device which may be a cellular telephone, or an Interactive Voice Recognition (IVR) system. For example, Table 2 illustrates relevant modules in the user agent 102.

TABLE 2

| Module Name | Package |
|---|---|
| UserAgent.java | com.caboodlenetworks.agents.user |
| UserRecruitResponderBehaviour.java | com.caboodlenetworks.agents.user |
| UserRecruitInitiatorBehaviour.java | com.caboodlenetworks.agents.user |
| UserSendSmsResultsBehaviour.java | com.caboodlenetworks.agents.user |

In addition, the user agent 102 creates unique interface content to match the requirements of the end users' device. In this way, any domain specific knowledge concentrates at the service agent 104.

The service agent 104 provides the core intelligence for the system by accepting requests from the user agent 102, making queries against the ontology, sending search queries to a search agent 108, and generating abstract user interfaces as a result back to the user agent 102. An abstract user interface can be an XML representation of a user interface that is device-agnostic. The service agent 104 also loads different profiles to allow for the searching of different categories of information. For example, Table 3 illustrates relevant modules in the service agent 104.

TABLE 3

| Module Name | Package |
|---|---|
| ServiceAgent.java | com.caboodlenetworks.agents.service |
| ServicePurchaseRecruitResponderBehaviour.java | com.caboodlenetworks.agents.service |
| ServiceRecruitInitiatorBehaviour.java | com.caboodlenetworks.agents.service |
| ServiceRecruitResponderBehaviour.java | com.caboodlenetworks.agents.service |
| ServiceSendUIBehaviour.java | com.caboodlenetworks.agents.service |

The search agent 108 issues SQL queries against the relational database and forwards the results of the query to a content download server (CDS agent) 116 for further filtering. For example, Table 4 illustrates relevant modules in the search agent 108.

TABLE 4

| Module Name | Package |
|---|---|
| SearchAgent.java | com.caboodlenetworks.agents.search |
| SearchCDSInitiatorBehaviour.java | com.caboodlenetworks.agents.search |
| SearchRecruitInitiatorBehaviour.java | com.caboodlenetworks.agents.search |
| SearchRecruitResponderBehaviour.java | com.caboodlenetworks.agents.search |

The CDS agent 116 initiates a download task from the wireless operator's content download system 120 to transfer to the end users' wireless device, filter search results, and record purchases. The CDS agent 116 then sends the data set on to a personalization agent 112 for further refinement. For example, Table 5 illustrates relevant modules in the CDS agent 116.

TABLE 5

| Module Name | Package |
|---|---|
| CDSAgent.java | com.caboodlenetworks.agents.cds |

The personalization agent 112 reduces the data set further, based on specific methodologies, and determines if data set items were previously purchased and if so, whether their licenses have expired. Methodologies based on user history, user preferences, user demographics, user location, and user temporal qualities may be used to select appropriate results. In addition, it reduces the quantity of the results to a manageable number and it removes any duplicate results. The personalized results are then sent back to the service agent 108. For example, Table 6 illustrates relevant modules for the personalization agent 112.

TABLE 6

| Module Name | Package |
|---|---|
| PersonalizationAgent.java | com.caboodlenetworks.agents.personalization |
| PersonalizationCDSInformBehaviour.java | com.caboodlenetworks.agents.personalization |
| PersonalizationRecruitInitiatorBehaviour.java | com.caboodlenetworks.agents.personalization |
| PersonalizationSendResultsBehaviour.java | com.caboodlenetworks.agents.personalization |

One embodiment of the invention, further comprises a cleaner agent that provides a mechanism for removing old, expired session data from a session_state and a session_attribute table. For example, Table 7 illustrates relevant modules in a cleaner agent, Table 8 illustrates a session_state table. and Table 9 illustrates a session_attribute table.

TABLE 7

| Module Name | Package |
|---|---|
| CleanerAgent.java | com.caboodlenetworks.agents.cleaner |
| Device.java | com.caboodlenetworks.agents.cleaner |
| TimeoutSessionBehaviour.java | com.caboodlenetworks.agents.cleaner |

TABLE 8

| ColumnName | DataType | PrimaryKey | Null? |
|---|---|---|---|
| session_id | VARCHAR(250) | Y | N |
| last_activity | DATE | | Y |
| Expiry | DATE | | N |

TABLE 9

| ColumnName | DataType | PrimaryKey | Null? |
|---|---|---|---|
| session_id | VARCHAR(250) | FK | N |
| Name | VARCHAR(50) | | N |
| Value | VARCHAR(250) | | Y |

One embodiment of the invention comprises a recruiter agent 114 for coordinating among different agents, and a content download the server agent 116 for initiating downloads of the search results and for returning the refined search results to the personalization agent 112. For example, Table 10 illustrates relevant modules for the recruiter agent 114.

TABLE 10

| Module Name | Package |
|---|---|
| RecruiterAgent.java | com.caboodlenetworks.agents.recruiter |
| RecruiterResponderBehaviour.java | com.caboodlenetworks.agents.recruiter |

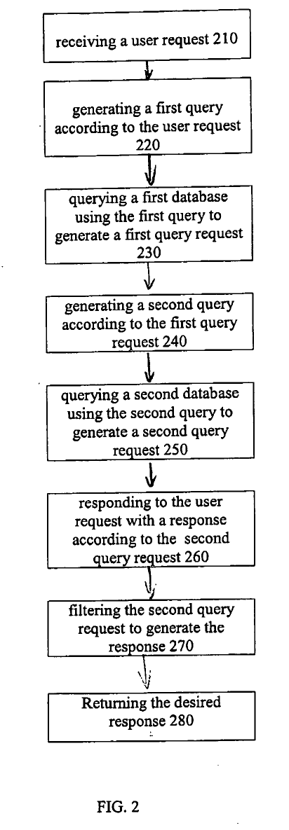

FIG. 2 is a block diagram of a method of data processing and content retrieval 200 according to the invention. The method of data processing and content retrieval 200 comprising the steps of receiving a user request 210 from a user interface, for example a SMS agent. The user request can be a text input, a menu selection, or a voice input.

The method of data processing and content retrieval further comprising the steps of generating a first query according to the user request 220, querying a first database using the first query to generate a first query request 230, generating a second query according to the first query request 240, querying a second database using the second query to generate a second query request 250, responding to the user request with a response according to the second query request 260, and filtering the second query request to generate the response 270.

The filtering process can be achieved according to relevance to the intent of the user request. In another embodiment of the invention, the second query request is filtered according to the user's device type. In another embodiment of the invention, the second query request is filtered according to an implicit preference and the implicit preference is indicated in previous history. In another embodiment of the invention, the second query request is filtered according to whether content has been previously acquired by a user of the request.

Finally, the desired response is returned to the user via the user interface 280, for example, such as an SMS agent.

Below is an example of the system and method of data processing and content retrieval. An end user keys into a WAP interface the query to search for ringtones, for example, “Metallica.” The user request is received 210.

The first query is generated according to the user request 220 by triggering a Web application to send a message to the recruiter agent 114. The message includes the query itself destined for the user agent 102 and a proxy message that wraps the inner query message with routing information.

The recruiter agent 114 opens the proxy message and queries in a first database using the first query to generate the first request 230 to request the recruiter agent 114 to locate a user agent 102 that can process the requesting query. The recruiter agent 114 locates a matching user agent from its pool or creates a new one as required. Subsequently, the recruiter agent 114 extracts and sends the inner message and sends it to the user agent 102.

The user agent 102 receives the message and initiates a request to the recruiter agent 114 to find an appropriate service agent 104 to handle the query based on the query type. A second query request is generated using the second query in a second database 260. A proxy message of the request with the query message embedded within is sent to the recruiter agent 114.

The service agent 104, which has, loaded profiles for handling different domain queries when it started, proceeds to determine the type of request. The request could be for the Main Menu, a search request, a user selection of an item from previously returned results, a purchases request, or a purchase confirmation. The second query is thus filtered to generate the response 270.

If it is a query request, the service agent 104 issues an RDQL (RDF Data Query Language) query against the ontology, as detailed in the below LISTING 1, which is stored in standardized OWL format. This sample ringtone.owl ontology allows for a query for the string “Metallica” to return similar artists by way of a <SimilarArtists> XML tag.

LISTING 1

<?xml version=“1.0”?>
<rdf:RDF

xmlns:rdf=“http://www.w3.org/1999/02/22-rdf-syntax-ns#”
xmlns:rdfs=“http://www.w3.org/2000/01/rdf-schema#”
xmlns:owl=“http://www.w3.org/2002/07/owl#”
xmlns=“http://www.owl-ontologies.com/unnamed.owl#”
xml:base=“http://www.owl-ontologies.com/unnamed.owl”>

<owl:Class rdf:ID=“Artist”>

<rdfs:comment>A musical group or individual</rdfs:comment>
<rdfs:subClassOf rdf:resource=“#Entity”/>
<rdfs:label xml:lang=“en”>Artist</rdfs:label>

</owl:Class>
<owl:Class rdf:ID=“EntityName”/>
<owl:Class rdf:ID=“Group”>

<rdfs:subClassOf>

<owl:Class rdf:ID=“Artist”/>

</rdfs:subClassOf>

</owl:Class>
<owl:Class rdf:ID=“Person”>

<rdfs:subClassOf>

<owl:Class rdf:about=“#Artist”/>

</rdfs:subClassOf>

</owl:Class>
<owl:Class rdf:about=“#Artist”>

<rdfs:subClassOf rdf:resource=“#Entity”/>

</owl:Class>
<owl:ObjectProperty rdf:ID=“SimilarArtists”>

<rdfs:range rdf:resource=“#Artist”/>
<rdfs:domain rdf:resource=“#Artist”/>

</owl:ObjectProperty>
<owl:FunctionalProperty rdf:ID=“Name”>

<rdfs:range

rdf:resource=“http://www.w3.org/2001/XMLSchema#string”/>

<rdf:type

rdf:resource=“http://www.w3.org/2002/07/owl#DatatypeProperty”/>

</owl:FunctionalProperty>
<owl:FunctionalProperty rdf:ID=“PresentedName”>

<rdfs:range rdf:resource=“#EntityName”/>
<rdfs:domain rdf:resource=“#Entity”/>
<rdf:type

rdf:resource=“http://www.w3.org/2002/07/owl#ObjectProperty”/>

</owl:FunctionalProperty>
<EntityName rdf:ID=“Music_Individual_Name_Metallica”>

<rdfs:label xml:lang=“en”>Metallica</rdfs:label>

</EntityName>
<Group rdf:ID=“Music_Individual_Group_Aerosmith”>

<PlaysInstrument>

<Instrument rdf:ID=“Music_Instrument_Guitar”/>

</PlaysInstrument>

</Group>
<Group rdf:ID=“Music_Individual_Group_Boston”/>
<Group rdf:ID=“Music_Individual_Group_ACDC”>

<SimilarArtists>

<Group rdf:ID=“Music_Individual_Group_Metallica”>

<SimilarArtists

rdf:resource=“#Music_Individual_Group_ACDC”/>

<PlaysInstrument

rdf:resource=“#Music_Instrument_Guitar”/>

<SimilarArtists

rdf:resource=“#Music_Individual_Group_Aerosmith”/>

</Group>

</SimilarArtists>
<SimilarArtists

rdf:resource=“#Music_Individual_Group_Aerosmith”/>

</Group>

</rdf:RDF>

Given this OWL file, the service agent 104 issues a query in RDQL format such as follows:

SELECT *

| | |
|---|---|
| WHERE | (?class, <http://www.w3.org/2000/01/rdf-schema#label>, |
| ?label), | |
| (?class, | |

<http://www.caboodlenetworks.com/ringtones#PresentedName>, ?name)
AND (?label =˜ /metallica/i)

The service agent 104 then queries the name_mapping table, e.g. as shown in TABLE 10, to find the recognized name of the artist. An example of such a query is:

select name from name_mapping where class_id =
‘http://www.caboodlenetworks.com/ringtones#Music_Individual_Group
_Metallica’

In this example, no matches are found so the system initiates a search for artists who are similar to the requested artist. The following is an example of RDQL query provides such information:

SELECT ?artist

| | |
|---|---|
| WHERE | (?class, <http://www.w3.org/2000/01/rdf-schema#label>, |
| ?label), | |
| (?class, | |

<http://www.caboodlenetworks.com/ringtones#SimilarArtists>,
?artist)
AND (?label =˜ /metallica/i)

The query returns the following matches from the ontology:
Music_Individual_Group_ACDC
Music_Individual_Group_Aerosmith

This information is returned to the user agent in the form of an abstract UI, which is a representation of user interface elements but without any layout or look and feel information.

The user agent receives this abstract UI and transforms it into a visible or audible interface to present the results to the end user. In this example, the caller sees a listing of two alternate bands from which to select. If the user selects one of the presented artists, a new query is initiated against the service agent but this time with identifier of the selected artist. This is referred to as a selection request.

The service agent 104 receives the identifier and first builds a SQL database query to get the real name of the artist based on the id passed from the name_mapping table in Table 11 with a query of the format:

select name from name_mapping where id=61

TABLE 11

| ColumnName | DataType | PrimaryKey | Null? |
|---|---|---|---|
| id | INTEGER | Y | Y |
| class_id | VARCHAR(150) | | Y |
| name | VARCHAR(100) | | Y |

In our example, the query returns the artist named “Aerosmith.”

Then the service agent 104 builds a SQL query for matching entities within the ringtones table in TABLE 12 based on the artist name. An example query might be as follows:

select artist, ringtones_id, song_title, genre from ringtones
where artist = ‘Aerosmith’

TABLE 12

| ColumnName | DataType | PrimaryKey | Null? |
|---|---|---|---|
| ringtones_id | INTEGER | Y | N |
| song_title | VARCHAR(150) | | N |
| Genre | VARCHAR(50) | | N |
| Ringtones | VARCHAR(150) | | Y |
| Artist | VARCHAR(100) | | Y |

This query is sent to the search agent 108 for processing, again by requesting the recruiter agent to find an available agent.

The search agent 108 receives the SQL query and executes it against the relational database. The results of this query are sent to the CDS agent 116 for post-processing.

The CDS agent 116 sees this as a Match request and modifies the results based on the capabilities of the caller's wireless handset. These results are sent to a personalization agent 112.

The personalization agent 112 makes sure that the ringtones available have not already been purchased, reduces the number of results to match user preferences in TABLE 13, and removes any duplicate entries.

TABLE 13

| ColumnName | DataType | PrimaryKey | NotNull | Comment |
|---|---|---|---|---|
| Subscriber_id | VARCHAR(12) | | NN | |
| Key | VARCHAR(50) | | NN | |
| Value | VARCHAR(100) | | NN | |

In this example, five songs are found to match the request. The results are sent back to the service agent 104, this time bypassing the recruiter agent 114.

The service agent 104 creates a user interface with the list of songs to be presented to the user and sends the UI to the user agent 102. If the user sees a desired item, the end user selects it from the presented list. This request initiates a purchase request to the user agent 102. The user agent 102 sends the purchase request to the service agent 104.

The service agent 104 creates a confirmation abstract interface to get confirmation of the purchase and provides information about the cost of the transaction. The UI is sent to the user agent 102 in the form of an abstract UI. The user agent 102 transforms the confirmation UI into a Web interface and returns the results to the Web server for presentation to the end user.

Finally, the end user confirms the purchase on his or her device and initiates a purchase request via the Web server to the user agent 102. The user agent 102 takes the confirmation request and forwards it to the service agent 104, which notifies the CDS agent 116 of the purchase and subsequently triggers the wireless operator's Content Delivery System to initiate the purchase.

The service agent 104 sends a “Thank You” message to the caller along with the Main Menu abstract UI. The end user receives a SMS message from the wireless operator with the ringtone or with a link to the ringtone. The desired response is thus returned to the user 280.

An agent framework, namely “JADE” (http://jade.tilab.com), is employed to manage the base generic agent functionality, such as starting the system, moving messages between agents, and the scheduling of agent behaviors. The system is configured by a file that is input into JADE. Below is an example of such a file in XML format:

<?xml version=“1.0”?>
<jade-service xmlns:xsi=“http://www.w3.org/2001/XMLSchema-instance”

xsi:noNamespaceSchemaLocation=“JADE-1_0.xsd”
serviceArgs=“-dump”
jadeArgs=“-dump import:jadeboot.properties”
note=“All agents except RMA will auto restart.”>

<agent name=“RMA” class=“jade.tools.rma.rma” gui=“true” />
<agent name=“gateway”

class=“com.hp.bluejade.agent.SocketProxy”
args=“infoLevel:3”
restart=“true” />

<agent name=“Recruiter”

class=“com.caboodlenetworks.agents.recruiter.RecruiterAgent”
args=“infoLevel:3”
restart=“true”/>

<agent name=“CDS” class=“com.caboodlenetworks.agents.cds.CDSAgent”

restart=“true”
args=“infoLevel:3”/>

<agent name=“Cleaner”

class=“com.caboodlenetworks.agents.cleaner.CleanerAgent”
restart=“true”
args=“infoLevel:3”/>

</jade-service>

In this example, the file specifies five agents. The agents implementing this invention are a gateway, such as an SMS agent, a recruiter, a CDS agent, and a cleaner agent. The RMA (Remote Monitoring Agent) is an optional JADE system agent. The gateway, such as an SMS agent, can be specified as a JADE startup parameter. All the other agents, i.e. the user agent, the service agent, the search agent, and the personalization agent, are started by the recruiter agent. The agent class attribute specifies the Java class implementing the agent. The agent args attribute allows the specification of arguments to the given agent, in this case often setting a logging level. The agent restart attribute specifies whether JADE should restart an agent that stops. In the outer jade-service tag of the XML file, the serviceArgs and jadeArgs attributes specify various startup parameters. That tag's not” attribute is a comment.

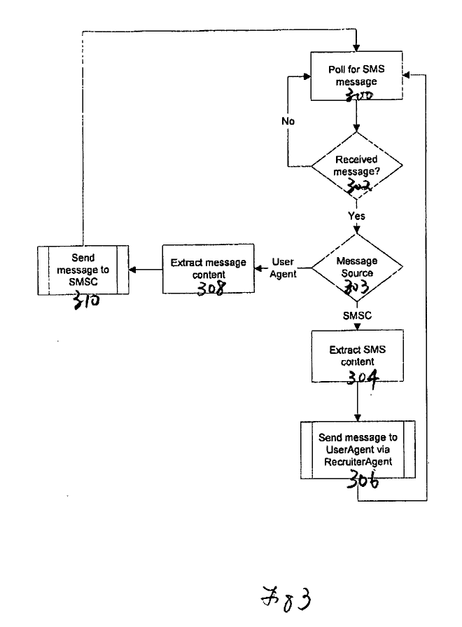

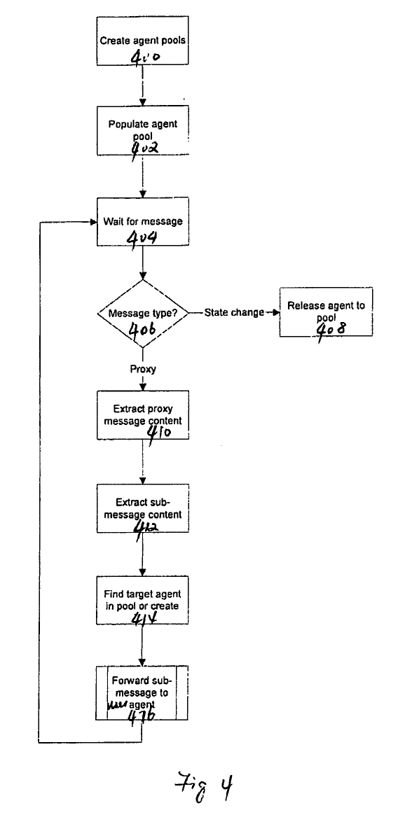

FIG. 3 is a flow diagram of a method of data processing and content retrieval using an SMS agent according to the invention. The SMS agent polls for an SMS message 300 from a user device, such as a cell phone. The SMS agent then determines whether it has received an SMS message 302. If it has not received an SMS message, the SMS agent continues to poll for an SMS message. It then determines the source of the message 303. If the SMS agent has received an SMS message, it extracts the SMS message content 304 and subsequently sends the SMS message to a user agent via a recruiter agent 306. If the message source is the user agent, then it extracts the message content 308 and send the message to the SMSC 310. The specific processes that take place in the recruiter agent are illustrated in FIG. 4.

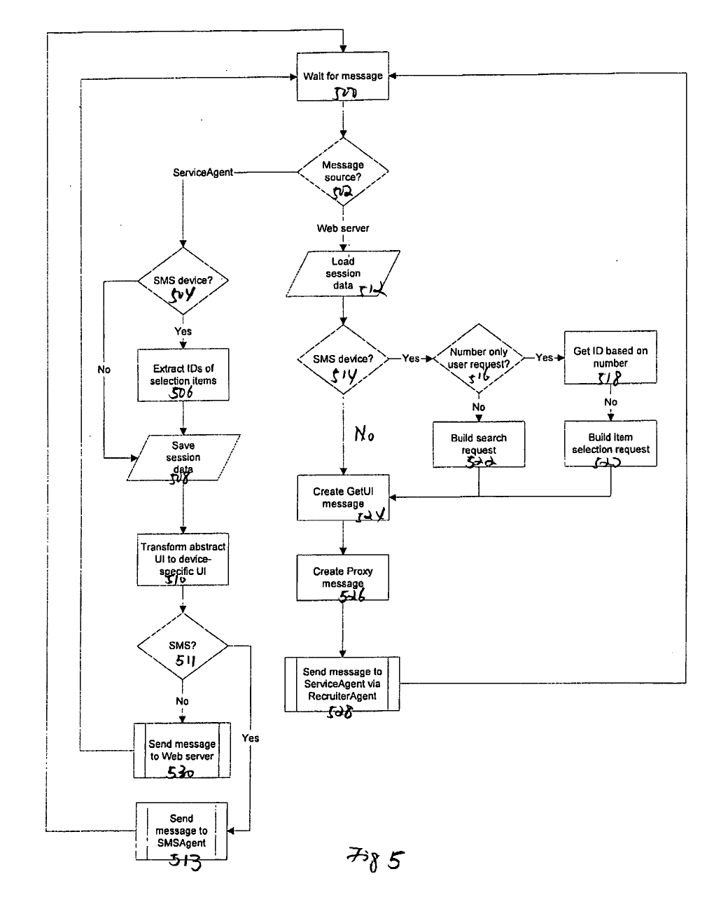

FIG. 4 is a flow diagram of data processing within a recruiter agent according to the invention. The recruiter agent creates various agent pools 400 and populates the agent pools 402. Then, the recruiter agent waits for a message from one of the other agents 404. The message includes either an enclosed sub-message and a proxy message that wraps that sub-message with routing information or an indication of state change. The recruiter agent determines the type of the message 406. If the message indicates agent state change, the recruiter agent releases the agent to the agent pool 408. If the message is a proxy message, the recruiter agent extracts proxy message content 410 and extract sub-message content 412. Then, the recruiter agent proceeds to find the target agent in the agent pool or create one as required 414. Finally, the recruiter agent forwards the sub-message to a user agent 416. The specific processes that take place in the user agent are illustrated in FIG. 5.

FIG. 5 is a flow diagram of a method of data processing and content retrieval using a user agent according to the invention. The user agent waits for a message 500. Upon receiving the message, the user agent determines the source of the message 502.

If the message comes from a service agent, the user agent further determines whether the source of the message is an SMS device 504. If the source of the message is an SMS device, the user agent proceeds to extract identifications of the desired selection items 506 and save the session data 508. If the source of the message is not an SMS device, the user agent proceeds to save the session data 508. One example of sample session data is illustrated in Table 9. Subsequently, the user agent transforms the abstract user interface (UI) to a device-specific UI 510. The user agent then determines if the message is SMS 511, in which case it sends the message to the SMS Agent via the Recruiter Agent 513, or if not it sends the message to the Web server 530.

If the message comes from a Web server 502, the user agent begins to load the session data 512. Then, the user agent determines whether the message originates from an SMS device 514. If the message originates from an SMS device, the user agent proceeds to determine whether the request is in the form of a number that needs to be converted to an identifier 516. If yes, the user agent gets identification based on the number 518 and then builds the item selection request 520. If the answer is no, the user agent builds the search request 522 or to build item selection request.

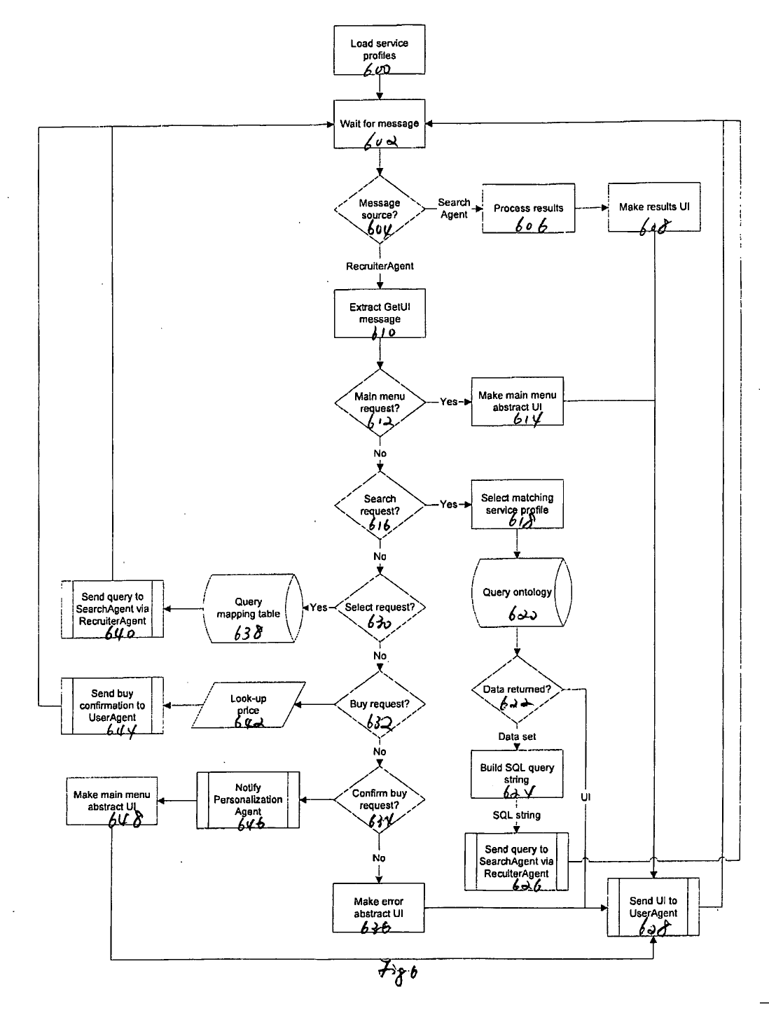

The user agent creates a GetUI message 524 either with the request built in 520 or 522 if the message originated from an SMS device or with no embedded search request if the message did not originate from an SMS device and creates a proxy message 526. Finally, the user agent sends the proxy message to the service agent via the recruiter agent 528. The specific processes that take place in the service agent are illustrated in FIG. 6.

FIG. 6 is a flow diagram of data processing using a service agent according to the invention. The service agent loads the service profiles 600 and waits for a message 602. Upon receiving a message, the service agent determines the sources of the message 604. If the message comes from the search agent, the data process reaches a result 606. The service agent labels the results with user identifications (UI) 608 and sends the UIs to the user agent to communicate with the user 628.

If the service agent determines that the message comes from a recruiter agent, the service agent extracts the GetUI message 610. The service agent then proceeds to determine whether the message is a main menu request 612. If the message is a main menu request, the service agent makes a main menu abstract UI 614 to send the UI to the user agent 628.

If it determines that the message is not a main menu request, the service agent proceeds to determine whether the message is a search request 616. If yes, the service agent selects a matching service profile from the query ontology 618, 620. The service agent proceeds to determine whether the data were previously returned data 622. If yes, the UI is sent to the user agent 628; if no, the service agent builds a SQL query string 624 and sends the query to the search agent via the recruiter agent 626 and then waits for another input message 602.

If the service agent determines that the request is not a search request 616, it proceeds to determine whether it is a select request 630. If yes, the service agent proceeds to query the query mapping table 638 and sends the query to the search agent via the recruiter agent 640 and then wait for another input message 602. If the service agent determines that the request is not a select request, it proceeds to determine whether it is a buy request 632. If it is determined that the request is a buy request, the service agent proceeds to look up the price 642 and then sends a buy confirmation to the user agent 644, subsequently waiting for another input message 602.

If the service agent determines that the request is not a buy request, it proceeds to decide whether it is a buy request confirmation or not 634. If the message is not a buy request confirmation, the service agent generates an error abstract UI message 636 and then sends the error UI message to the user agent 628.

If the service agent decides that the message is a buy request confirmation, it proceeds to notify the personalization agent 646 and to make main menu abstract UI 648. Finally, the service agent returns the UI to the user agent 628.

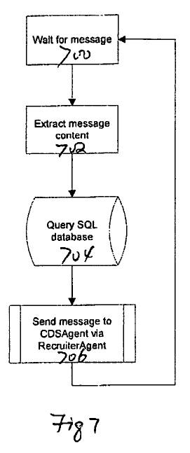

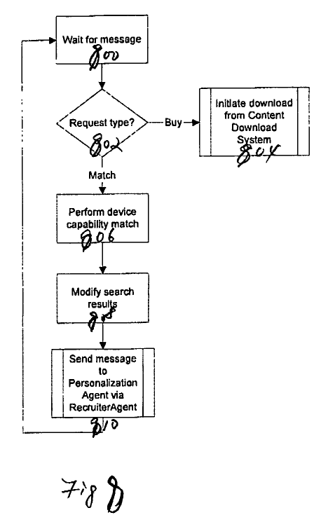

FIG. 7 is a flow diagram of a method of data processing using a search agent according to the invention. The search agent waits for a message 700. Upon receiving the message, the search agent extracts the message content 702 and performs a search in the query SQL database 704. The search agent sends the message to a CDS agent via a recruiter agent 706. The specific processes that take place in the CDS agent are illustrated in FIG. 8.

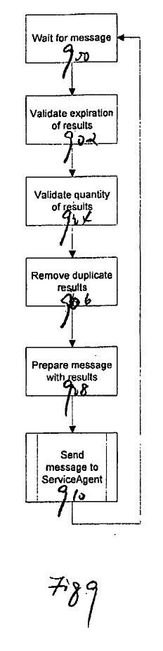

FIG. 8 is a flow diagram of a method of data processing using a CDS agent according to the invention. A CDS agent waits for a message 800. Upon receiving a message, the CDS agent determines the type of the message 802. If the CDS agent determines that the message is a buy request, it initiates a download from the content download system 804. If the CDS agent determines the message is a match request, it performs the match based on the capabilities of the message originating device, for example, the caller's wireless handset 806. The CDS agent then modifies the search results 808 and sends the message to a personalization agent via the recruiter agent 810. The specific processes that take place in the personalization agent are illustrated in FIG. 9.

FIG. 9 is a flow diagram of a method of data processing using a personalization agent according to the invention. The personalization agent waits for a message 900. Upon receiving the message, the personalization agent validates the expiration of results 902 and validates the quantity of results 904. If there are duplicate results, the personalization agent removes the duplicate results 906 and prepare a message with the results 908. Finally, the personalization agent sends the message to the service agent 910.

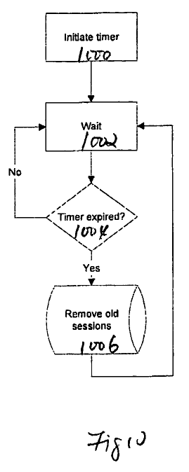

FIG. 10 is a flow diagram of a method of data processing using a cleaner agent according to the invention. The cleaner agent initiates a timer 1000 and waits for events to take place 1002. The cleaner agent proceeds to determine whether the preset time has expired 1004. If the timer has expired, the cleaner agent proceeds to remove old sessions and clean up the system 1006. If the timer has not expired, the cleaner agent continues to wait 1002 until a set time has expired.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method in a data processing system for content retrieval, comprising the steps of:
receiving a user request;
generating a first query according to the user request;
querying a first database using the first query to generate a first query request;
generating a second query according to the first query request;
querying a second database using the second query to generate a second query request.

2. The method of claim 1, further comprising the steps of:
responding to the user request with a response according to the second query request;
and filtering the second query request to generate the response.

3. The method of claim 2, wherein filtering of the second query request is performed according to relevance of the intent of the user request.

4. The method of claim 3, wherein the second query request is filtered according to a device type.

5. The method of claim 3, wherein the second query request is filtered according to a preference.

6. The method of claim 5, wherein the preference is indicated in a previous history, geographical location and temporal changes.

7. The method of claim 3, wherein the second query request is filtered according to whether content has been previously acquired by a user making the request.

8. The method of claim 1, wherein the user request comprises one of: text input; menu selection; and voice input.

9. The method of claim 1, wherein the first database comprises a knowledgebase.

10. The method of claim 9, wherein the knowledgebase comprises an ontology.

11. The method of claim 10, wherein the second database comprises content and services.

12. The method of claim 10, wherein the step of querying of the first database
comprises the step of:
understanding an intent of the user request.

13. The method of claim 10, wherein the step of querying of the first database
comprises the step of:
translating an intent of the user request.

14. The method of claim 10, wherein the step of querying of the first database
comprises the step of:
expanding an intent of the user request.

15. A machine readable medium containing instructions which when executed on a data processing system cause the data processing system to perform a method, the method comprising the steps of:
receiving a user request;
determining a user intent from the user request; and
searching a database according to the user intent.

16. The medium of claim 15, wherein the method further comprises the step of:
filtering a query result from the database to generate a response to the user request.

17. The medium of claim 15, wherein the user intent is determined according to an ontology.

18. A data processing system, comprising:
a user agent for receiving a user request;
a service agent for determining a query for the user request according to a knowledgebase; and
a search agent for searching a content database according to the query.

19. The data processing system of claim 18, further comprising:
a personalization agent for filtering a query result from the content database to generate a personalized response to the user request.

20. The data processing system of claim 18, wherein the knowledgebase comprises an ontology.

21. The data processing system of claim 18, further comprising: a cleaner agent for removing expired data available to the agents.

22. The data processing system of claim 18, further comprising:
a recruiter agent for locating the user agent, the service agent, the search agent, the cleaner, and the personalization agent, and for forwarding a plurality of user requests among the user agent, the service agent, the search agent, the cleaner agent, and the personalization agent.
